(19) United States
(12) Patent Application Publication
(10) Pub. No.: US 2025/0145031 A1
(43) Pub. Date: May 8, 2025

(54) ACTUATOR

(71) Applicants: HYUNDAI MOTOR COMPANY, SEOUL (KR); KIA CORPORATION, SEOUL (KR); KOREA ELECTRIC TERMINAL CO., LTD, INCHEON (KR)

(72) Inventors: Yun Jae Jung, Suwon-si (KR); Seung Min Yoo, Hwaseong-si (KR); Byeong Kyu Kim, Gwangmyeong-si (KR); Young Jong Lee, Seoul (KR); In Ho Kim, Seongnam-si (KR); Seong Chul Hong, Incheon (KR); Jae Yeob Park, Gunpo-si (KR)

(73) Assignees: HYUNDAI MOTOR COMPANY, SEOUL (KR); KIA CORPORATION, SEOUL (KR); KOREA ELECTRIC TERMINAL CO., LTD, INCHEON (KR)

(21) Appl. No.: 18/746,410

(22) Filed: Jun. 18, 2024

(30) Foreign Application Priority Data
Nov. 8, 2023 (KR) 10-2023-0153799

(51) Int. Cl. B60L 53/16

(52) U.S. Cl. CPC B60L 53/16

(57) ABSTRACT

An actuator includes a housing, a gear part rotatably provided on the housing, a rod having a contact protrusion and configured to be movable upward or downward relative to the housing depending on a rotation of the gear part, and a switch provided in the housing and configured to define an electric circuit electrically connected to a switch resistor, the switch being configured to connect or disconnect (ON/OFF) the electric circuit depending on contact of the contact protrusion, the switch including a safety switch driving section in which a state in which a movement of the contact protrusion relative to the switch is allowed and the electric circuit is connected (ON) is maintained, and the switch and the contact protrusion positioned adjacent to each other so that the movement of the contact protrusion relative to the switch is performed in the safety switch driving section, thereby improving stability and reliability.

### CROSS REFERENCE TO RELATED APPLICATIONS

This application claims priority to and the benefit of Korean Patent Application No. 10-2023-0153799 filed in the Korean Intellectual Property Office on Nov. 8, 2023, the entire contents of which are incorporated herein by reference.

### TECHNICAL FIELD

The present disclosure relates to an actuator, and more particularly, to an actuator capable of improving stability and reliability.

### BACKGROUND

In general, an electric vehicle is equipped with a battery and a motor and configured to obtain driving power, which is required to drive the electric vehicle, by operating the motor by using electrical energy stored in the battery.

Further, the electric vehicle is equipped with an actuator that suppresses an inadvertent withdrawal of a charger (locks the charger) during a process of charging the battery, and unlocks the charger when the process of charging the battery is completed.

In general, the actuator for a charger of an electric vehicle includes a drive part (e.g., a motor), a driving gear configured to be rotated by the drive part, and a rod configured to selectively lock or unlock the charger while being rectilinearly moved (e.g., raised or lowered) by the rotation of the driving gear. The locked state made by the rod may be maintained or released in response to a signal detected by a switch configured to detect an operating position (lifting position) of the rod.

However, in the related art, when a posture of the rod is changed (e.g., the rod is tilted) by an external force applied to the rod (e.g., an external force generated by interference of a latch when the charger is pulled), the switch erroneously operates because of a movement of the rod relative to the switch, which makes it difficult to detect an accurate operating position of the rod.

In particular, the locked state of the charger made by the rod needs to be stably maintained during the charging process. However, when the switch erroneously operates (an error occurs at the time of recognizing resistance of the switch) because of a change in posture of the rod caused by the external force (e.g., a tilt of the rod with respect to the switch), there is a problem in that the locked state of the charger made by the rod is released. For this reason, there is a problem in that the charging process is not normally performed or a charging voltage is not uniform, which increases the risk of the occurrence of safety accidents such as electric shock, fire, and explosion.

Therefore, recently, various studies have been conducted to minimize an erroneous operation of the actuator and improve stability and reliability, but the study results are still insufficient. Accordingly, there is a need to develop a technology to minimize an erroneous operation of the actuator and improve stability and reliability.

### SUMMARY

The present disclosure has been made in an effort to provide an actuator capable of improving stability and reliability.

In particular, the present disclosure has been made in an effort to minimize an erroneous operation of the actuator and minimize a charging error and a charging defect.

Among other things, the present disclosure has been made in an effort to detect an accurate operating position of a rod and minimize an erroneous operation of a switch caused by a change in posture of the rod even though an external force is applied to the rod.

The present disclosure has also been made in an effort to prevent a charging interruption and an inability to detach a charger caused by an erroneous operation of the switch.

The objects to be achieved by the embodiments are not limited to the above-mentioned objects, but also include objects or effects that may be understood from the solutions or embodiments described below.

In order to achieve the above-mentioned objects, an exemplary embodiment of the present disclosure provides an actuator including a housing, a gear part rotatably provided on the housing, a rod having a contact protrusion and configured to be movable upward or downward relative to the housing depending on a rotation of the gear part, and a switch provided in the housing and configured to define an electric circuit electrically connected to a switch resistor, the switch being configured to selectively connect or disconnect (ON/OFF) the electric circuit depending on contact of the contact protrusion, in which the switch is defined to have a safety switch driving section in which a state in which a movement of the contact protrusion relative to the switch is allowed and the electric circuit is connected (ON) is maintained, and in which the switch and the contact protrusion are provided adjacent to each other so that the movement of the contact protrusion relative to the switch is performed in the safety switch driving section.

This is to improve stability and reliability of the actuator.

That is, in the related art, when a posture of the rod is changed (e.g., the rod is tilted) by an external force applied to the rod (e.g., an external force generated by interference of a latch when the charger is pulled), the switch erroneously operates because of a movement of the rod relative to the switch, which makes it difficult to detect an accurate operating position of the rod.

In particular, the locked state of the charger made by the rod needs to be stably maintained during the charging process. However, when the switch erroneously operates (an error occurs at the time of recognizing resistance of the switch) because of a change in posture of the rod caused by the external force (e.g., a tilt of the rod with respect to the switch), there is a problem in that the locked state of the charger made by the rod is released. For this reason, there is a problem in that the charging process is not normally performed or a charging voltage is not uniform, which increases the risk of the occurrence of safety accidents such as electric shock, fire, and explosion.

In contrast, in the embodiment of the present disclosure, the safety switch driving section in which the state in which the movement of the contact protrusion relative to the switch is allowed and the electric circuit is connected (ON) may be maintained is defined, and the switch and the contact protrusion are disposed adjacent to each other so that the movement of the contact protrusion relative to the switch is performed in the safety switch driving section. Therefore, it is possible to obtain an advantageous effect of minimizing an erroneous operation of the actuator and minimizing a charging error and a charging defect.

In particular, in the embodiment of the present disclosure, the movement of the contact protrusion relative to the switch is performed in the safety switch driving section, such that an erroneous operation of the switch may be minimized and an accurate operating position of the rod may be detected even though an external force is applied to the rod. Therefore, it is possible to prevent abnormal withdrawal and separation of the charger caused by the external force during the process of charging the battery.

The switch may have various structures in accordance with required conditions and design specifications.

According to the exemplary embodiment of the present disclosure, the switch may include a main body part provided in the housing and configured to define the electric circuit electrically connected to the switch resistor, and a contact part provided on the main body part and configured to be rectilinearly movable in a direction in which the contact part moves toward or away from the contact protrusion, the contact part being configured to selectively connect or disconnect the electric circuit while rectilinearly moving relative to the main body part depending on the contact of the contact protrusion.

According to the exemplary embodiment of the present disclosure, a total resistance value of the electric circuit may selectively vary depending on the connection or disconnection of the electric circuit.

According to the exemplary embodiment of the present disclosure, the movement of the contact protrusion relative to the switch may include at least any one of pushing of the rod relative to the housing by an external force applied to the rod and tilting of the rod relative to the housing.

According to the exemplary embodiment of the present disclosure, a maximum movement distance of the contact protrusion relative to the switch may be defined to be included in the safety switch driving section.

According to the exemplary embodiment of the present disclosure, the safety switch driving section may be defined to have a shorter length than an overall switch driving section of the switch in which the electric circuit may be connected (ON) by the contact of the contact protrusion.

The positions of two opposite ends of the overall switch driving section and the positions of two opposite ends of the safety switch driving section may be variously changed in accordance with conditions and design specifications.

According to the exemplary embodiment of the present disclosure, the overall switch driving section may be defined between a maximum pushing point of the switch and a switch disconnection point at which the electric circuit is disconnected, and the safety switch driving section may be defined between a first reference point, which is spaced apart from the maximum pushing point by a first reference distance in a direction in which the switch is pushed, and a second reference point spaced apart from the switch disconnection point by a second reference distance in the direction in which the switch is pushed.

The first reference distance and the second reference distance may be variously changed in accordance with the type and specifications of the switch.

According to the exemplary embodiment of the present disclosure, the maximum pushing point may be defined to be spaced apart from a reference point, which is defined on the housing, by 5.1 mm in the direction in which the switch is pushed, the switch disconnection point may be defined to be spaced apart from the reference point by 6.8 mm in the direction in which the switch is pushed, the first reference point may be defined to be spaced apart from the reference point by 5.8 mm in the direction in which the switch is pushed, and the second reference point may be defined to be spaced apart from the reference point by 6.4 mm in the direction in which the switch is pushed.

According to the exemplary embodiment of the present disclosure, a length of a contact section between the contact part and the contact protrusion in the upward/downward movement direction of the rod may be defined to be longer than a maximum pushing distance of the rod relative to the housing in the upward/downward movement direction of the rod (an axial direction of the rod).

This is based on the fact that when an external force is applied during the process of charging the battery, the rod may be pushed, and the contact between the contact protrusion and the switch is released (an erroneous operation occurs) as the rod is pushed. In the embodiment of the present disclosure, the length of the contact section is defined to be longer than the maximum pushing distance of the rod, such that it is possible to prevent the release of the contact between the contact protrusion and the switch (erroneous operation) and detect an accurate operating position of the rod even when the rod is pushed.

### BRIEF DESCRIPTION OF THE FIGURES

FIG. 1 is a view for explaining an actuator according to an embodiment of the present disclosure.

FIGS. 2 and 3 are views for explaining a rod and a switch of the actuator according to the embodiment of the present disclosure.

FIG. 4 is a view for explaining an electric circuit of the switch of the actuator according to the embodiment of the present disclosure.

FIG. 5 is a view for explaining a safety switch driving section of the switch of the actuator according to the embodiment of the present disclosure.

FIGS. 6 and 7 are views for explaining a tilted state of the rod of the actuator according to the embodiment of the present disclosure.

FIG. 8 is a view for explaining a pushed state of the rod of the actuator according to the embodiment of the present disclosure.

### DETAILED DESCRIPTION

Hereinafter, exemplary embodiments of the present disclosure will be described in detail with reference to the accompanying drawings.

However, the technical spirit of the present disclosure is not limited to some embodiments described herein but may be implemented in various different forms. One or more of the constituent elements in the embodiments may be selectively combined and substituted for use within the scope of the technical spirit of the present disclosure.

In addition, unless otherwise specifically and explicitly defined and stated, the terms (including technical and scientific terms) used in the embodiments of the present disclosure may be construed as the meaning which may be commonly understood by the person with ordinary skill in the art to which the present disclosure pertains. The meanings of the commonly used terms such as the terms defined in dictionaries may be interpreted in consideration of the contextual meanings of the related technology.

In addition, the terms used in the embodiments of the present disclosure are for explaining the embodiments, not for limiting the present disclosure.

In the present specification, unless particularly stated otherwise, a singular form may also include a plural form. The expression “at least one (or one or more) of A, B, and C” may include one or more of all combinations that can be made by combining A, B, and C.

In addition, the terms such as first, second, A, B, (a), and (b) may be used to describe constituent elements of the embodiments of the present disclosure.

These terms are used only for the purpose of discriminating one constituent element from another constituent element, and the nature, the sequences, or the orders of the constituent elements are not limited by the terms.

Further, when one constituent element is described as being ‘connected’, ‘coupled’, or ‘attached’ to another constituent element, one constituent element may be connected, coupled, or attached directly to another constituent element or connected, coupled, or attached to another constituent element through still another constituent element interposed therebetween.

In addition, the expression “one constituent element is provided or disposed above (on) or below (under) another constituent element” includes not only a case in which the two constituent elements are in direct contact with each other, but also a case in which one or more other constituent elements are provided or disposed between the two constituent elements. The expression “above (on) or below (under)” may mean a downward direction as well as an upward direction based on one constituent element.

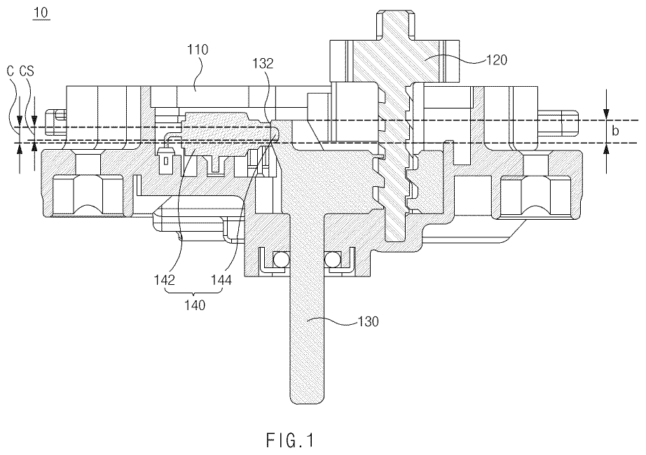

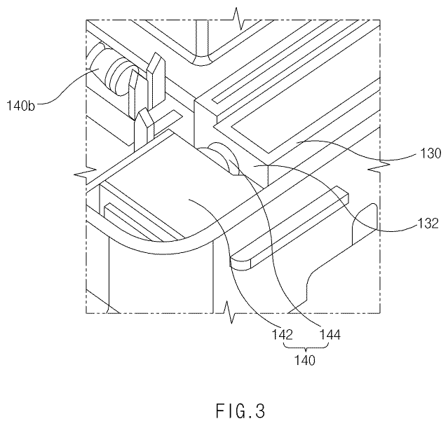

With reference to FIGS. 1 to 8, an actuator 10 according to an embodiment of the present disclosure includes a housing 110, a gear part 120 rotatably provided on the housing 110, a rod 130 configured to be raised or lowered relative to the housing 110 depending on the rotation of the gear part 120 and having a contact protrusion 132, and a switch 140 provided in the housing 110 and configured to define an electric circuit 140a electrically connected to a switch resistor 140b, the switch 140 being configured to selectively connect or disconnect (ON/OFF) the electric circuit 140a depending on contact of the contact protrusion 132. The switch 140 has a safety switch driving section SSDS in which a state in which a movement of the contact protrusion 132 relative to the switch 140 is allowed and the electric circuit 140a is connected (ON) is maintained. The switch 140 and the contact protrusion 132 are provided adjacent to each other so that the movement of the contact protrusion 132 relative to the switch 140 is performed in the safety switch driving section SSDS.

For reference, the actuator 10 according to the present disclosure may be used to selectively lock various objects in accordance with required conditions and design specifications. The present disclosure is not restricted or limited by the type and structure of the object.

Hereinafter, an example will be described in which the actuator 10 according to the embodiment of the present disclosure is used to selectively lock a charger for an electric vehicle.

With reference to FIG. 1, the actuator 10 includes the housing 110, the gear part 120, the rod 130, and the switch 140.

The housing 110 may have various structures having an accommodation space capable of accommodating the gear part 120, the rod 130, and the switch 140. The present disclosure is not restricted or limited by the structure and shape of the housing 110.

For example, the housing 110 may include a first cover, and a second cover configured to define the accommodation space collectively with the first cover. According to another embodiment of the present disclosure, the housing may be configured by assembling or coupling a single cover or three or more covers.

The gear part 120 is provided on the housing 110 and configured to be rotatable by driving power of a drive part.

The gear part 120 may be configured by combining a single gear or a plurality of gears. The present disclosure is not restricted or limited by the types and number of gears that constitute the gear part 120.

For example, the gear part 120 may include a worm gear (not illustrated) provided in the housing 110 in a horizontal direction and configured to be rotated by driving power of the drive part, a worm wheel (not illustrated) configured to engage with the worm gear and rotate, a spur gear (not illustrated) configured to engage with the worm wheel and rotate, a lever gear (not illustrated) configured to engage with the spur gear and rotate, and a spur worm gear (not illustrated) provided in a vertical direction (upward/downward direction) of the housing 110 and configured to engage with the lever gear and rotate.

With the above-mentioned structure, when the worm gear is rotated by driving power of the drive part, the worm wheel, the spur gear, the lever gear, and the spur worm gear may sequentially rotate in conjunction with the worm gear.

The rod 130 is configured to be movable upward or downward relative to the housing 110 in the vertical direction (upward/downward direction) of the housing 110 depending on the rotation of the gear part 120.

The upward and downward movements of the rod 130 may be implemented by the rotation of the gear part 120 in accordance with required conditions and design specifications in various ways. The present disclosure is not restricted or limited by the structure in which the gear part 120 and the rod 130 operate in conjunction with each other.

For example, a tooth portion of the rod 130 may be formed on a lateral portion of the rod 130 and engage with the gear part 120 (spur worm gear). The rod 130 may rectilinearly move (move upward or downward) in the upward/downward direction depending on the rotation of the gear part 120.

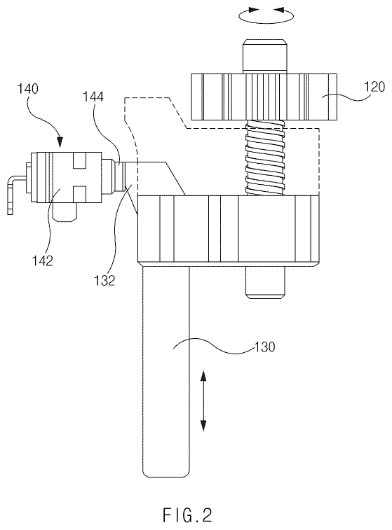

In addition, the contact protrusion 132 may protrude from an upper end of the rod 130 that faces the switch 140. When the rod 130 moves upward (based on FIG. 2), the contact protrusion 132 may come into contact with the switch 140.

The contact protrusion 132 may have various structures capable of coming into contact with the switch 140. The present disclosure is not restricted or limited by the structure and shape of the contact protrusion 132.

For example, the contact protrusion 132 may be provided in the form of an approximately quadrangular protrusion, and an inclined guide portion may be provided on a boundary between the contact protrusion 132 and the rod 130.

With the above-mentioned structure, when the rod 130 moves (downward), an end (contact part) of the switch 140 may come into contact with the contact protrusion 132 while moving along the inclined guide portion.

With reference to FIGS. 1 to 5, the switch 140 is configured to monitor an operating position of the rod 130 (a locking position when the rod is moved downward or an unlocking position when the rod is moved upward) in response to a signal generated when the rod 130 moves upward or downward.

More specifically, the switch 140 is provided in the housing 110 to define the electric circuit 140a electrically connected to the switch resistor 140b. The switch 140 is configured to selectively connect or disconnect (ON/OFF) the electric circuit 140a (connect or disconnect an electrical contact point) depending on the contact of the contact protrusion 132.

In the embodiment of the present disclosure, the configuration in which the switch 140 selectively turns on or off the electric circuit 140a is defined as a configuration in which the electric circuit 140a is defined as an open circuit or a closed circuit by the switch 140.

The switch 140 may have various structures in accordance with required conditions and design specifications. The present disclosure is not restricted or limited by the structure of the switch 140.

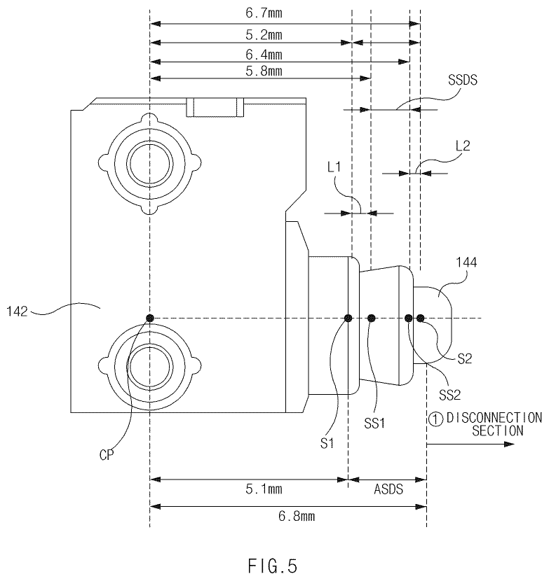

According to the exemplary embodiment of the present disclosure, the switch 140 may include a main body part 142 provided in the housing 110 and configured to define the electric circuit 140a electrically connected to the switch resistor 140b, and a contact part 144 provided on the main body part 142 and configured to be rectilinearly movable in a direction in which in which the contact part 144 moves toward or away from the contact protrusion 132 (a leftward/rightward direction based on FIG. 5), the contact part 144 being configured to selectively connect or disconnect the electric circuit 140a while rectilinearly moving relative to the main body part 142 depending on the contact of the contact protrusion 132.

For example, the main body part 142 may be provided in the form of an approximately quadrangular block. The contact part 144 may have an approximately hemispherical cross-sectional shape. The contact part 144 may be provided on one surface of the main body part 142 that faces the contact protrusion 132, and the contact part 144 may be rectilinearly movable elastically.

According to the exemplary embodiment of the present disclosure, a total resistance value of the electric circuit 140a may selectively vary depending on the connection or disconnection of the electric circuit 140a.

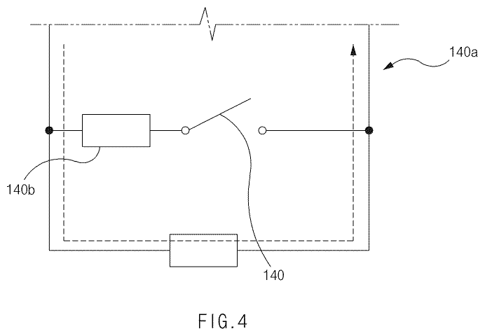

With reference to FIGS. 2 and 4, when the rod 130 moves to the locking position (moves downward), the contact part 144 is pushed by the contact protrusion 132, such that the electrical contact point of the switch 140 may be connected, and the total resistance value of the electric circuit 140a may be detected as a value including a resistance value of the switch resistor 140b.

In contrast, when the rod 130 moves to the unlocking position (moves upward), the pressing applied by the contact protrusion 132 is released (the contact protrusion moves away from the contact part), such that the electrical contact point of the switch 140 may be disconnected (released), and the total switch resistance value of the electric circuit 140a may be detected as a value excluding a resistance value of the switch resistor 140b.

According to the exemplary embodiment of the present disclosure, the switch 140 is defined to have the predefined safety switch driving section SSDS. The switch 140 and the contact protrusion 132 are positioned adjacent to each other so that the movement of the contact protrusion 132 relative to the switch 140 is performed in the safety switch driving section SSDS.

In this case, the safety switch driving section SSDS may be defined as a section in which the state in which the movement of the contact protrusion 132 relative to the switch 140 is allowed and the electric circuit 140a is connected (ON) is maintained (the state in which the electrical contact point is connected is maintained).

In addition, in the embodiment of the present disclosure, the movement of the contact protrusion 132 relative to the switch 140 may be defined as including at least any one of a process in which the rod 130 is pushed relative to the housing 110 by an external force applied to the rod 130 (the rod is pushed in the upward/downward direction) and a process in which the rod 130 is tilted relative to the housing 110.

This is based on the fact that when the posture of the rod 130 is changed (e.g., tilted) by an external force applied to the rod 130 (e.g., an external force generated by interference of a latch caused when a charger is pulled) when the external force is applied to the rod 130, the switch 140 operates erroneously because of the movement of the rod 130 relative to the switch 140 (an error occurs at the time of recognizing resistance of the switch because of the disconnection of the electrical contact point).

In contrast, in the embodiment of the present disclosure, the safety switch driving section SSDS is defined by the switch 140, and the movement of the contact protrusion 132 relative to the switch 140 is performed in the safety switch driving section SSDS. Therefore, it is possible to obtain an advantageous effect of minimizing an erroneous operation of the switch 140 and detecting an accurate operating position of the rod 130.

According to the exemplary embodiment of the present disclosure, a maximum movement distance of the contact protrusion 132 relative to the switch 140 may be defined to be included in the safety switch driving section SSDS.

In this case, the maximum movement distance of the contact protrusion 132 relative to the switch 140 may be understood as a distance that the contact protrusion 132 may maximally move relative to the switch 140 (e.g., the contact protrusion 132 moves in the direction in which the contact protrusion moves away from the switch as the rod tilts).

In addition, the configuration in which the maximum movement distance of the contact protrusion 132 relative to the switch 140 is included in the safety switch driving section SSDS may be understood as a configuration in which the contact point of the contact protrusion 132 (the contact point being in contact with the switch) is positioned within the safety switch driving section SSDS in the state in which the contact protrusion 132 has moved the maximum movement distance relative to the switch 140.

Further, because the maximum movement distance of the contact protrusion 132 relative to the switch 140 is included in the safety switch driving section SSDS, the state in which the electric circuit 140a of the switch 140 is connected (ON) may be maintained even though the contact protrusion 132 moves the maximum movement distance relative to the switch 140.

According to the exemplary embodiment of the present disclosure, the safety switch driving section SSDS may be defined to have a shorter length than an overall switch driving section ASDS of the switch 140 in which the electric circuit 140a may be connected (ON) by the contact of the contact protrusion 132.

In this case, the overall switch driving section ASDS may be defined as an overall section in which the electric circuit 140a of the switch 140 may be connected when the contact part 144 is pressed.

In particular, the safety switch driving section SSDS may be defined at an approximately central portion of the overall switch driving section ASDS so as to have a shorter length than the overall switch driving section ASDS.

The positions of two opposite ends of the overall switch driving section ASDS and the positions of two opposite ends of the safety switch driving section SSDS may be variously changed in accordance with conditions and design specifications. The present disclosure is not restricted or limited by the positions of the two opposite ends of the overall switch driving section ASDS and the positions of the two opposite ends of the safety switch driving section SSDS.

According to the exemplary embodiment of the present disclosure, the overall switch driving section ASDS may be defined between a maximum pushing point S1 of the switch 140 (a point at which the contact part of the switch is maximally pushed) and a switch disconnection point S2 at which the electric circuit 140a is disconnected (OFF) (a point at which the electrical contact point is disconnected). The safety switch driving section SSDS may be defined between a first reference point SS1, which is defined to be spaced apart from the maximum pushing point S1 by a first reference distance L1 in a direction in which the switch 140 is pushed, a second reference point SS2 that is spaced apart from the switch disconnection point S2 by a second reference distance L2 in the direction in which the switch 140 is pushed.

The first reference distance L1 and the second reference distance L2 may be variously changed in accordance with the type and specifications of the switch 140. The present disclosure is not restricted or limited by the first reference distance L1 and the second reference distance L2.

For example, the first reference distance L1 may be defined as about 0.7 mm, and the second reference distance L2 may be defined as about 0.3 mm.

According to the exemplary embodiment of the present disclosure, the maximum pushing point S1 may be defined to be spaced apart from a reference point CP, which is defined on the housing 110, by 5.1 mm in the direction in which the switch 140 is pushed (the leftward/rightward direction based on FIG. 5). The switch disconnection point S2 may be defined to be spaced apart from the reference point CP by 6.8 mm in the direction in which the switch 140 is pushed. The first reference point SS1 may be defined to be spaced apart from the reference point CP by 5.8 mm in the direction in which the switch 140 is pushed. The second reference point SS2 may be defined to be spaced apart from the reference point CP by 6.4 mm in the direction in which the switch 140 is pushed.

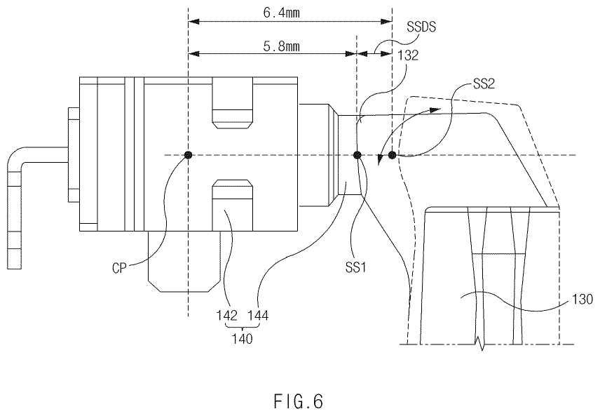

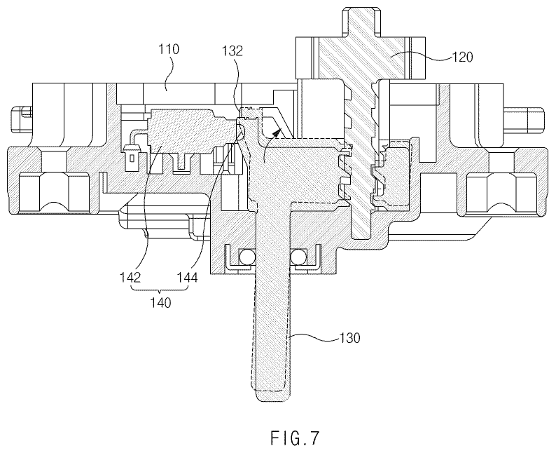

This is based on the fact that the operation of the switch 140 is determined depending on the amount of pushing of the switch 140 (the amount of pushing of the contact part) made by the contact of the rod 130 (the contact of the contact protrusion), and the rod 130 may tilt (the rod may tilt relative to the housing), as illustrated in FIGS. 6 and 7, when an external force is applied (an external force is applied as the user pulls the charger upward, downward, leftward, rightward, forward, or rearward) during the process of charging the battery. In the embodiment of the present disclosure, the safety switch driving section SSDS, in which the state in which the electric circuit 140a is connected may be maintained even when the rod 130 tilts, is set in consideration of the amount of pushing of the switch 140.

That is, based on the switch 140 having the specifications in which a disconnection section of the switch 140 is 6.8 to 7.5 mm based on the reference point CP defined on the housing 110, a driving section of the switch 140 is 6.8 to 7.4 mm based on the reference point CP, and the maximum pushing point S1 of the switch 140 is 5.1 mm based on the reference point CP, a section, in which the disconnection section and the driving section overlap, may be 6.8 to 7.4 mm, the operation of the switch 140 may be detected in a section of 5.1 to 6.8 mm, which is a section outside the maximum pushing point S1 of 5.1 mm (a right section from the maximum pushing point based on FIG. 5), and a basic safety section of the switch 140 may be set to 5.2 to 6.7 mm based on the reference point CP in consideration of tolerances, margins, and the like. However, in the embodiment of the present disclosure, in consideration of the tilt of the rod 130 relative to the housing 110, the safety switch driving section SSDS is defined to 5.8 to 6.4 mm that is a section longer than 5.2 mm, i.e., a minimum length of the basic safety section and shorter than 6.7 mm, i.e., a maximum length of the basic safety section.

According to the exemplary embodiment of the present disclosure, a length of a contact section CS between the contact part 144 and the contact protrusion 132 in the upward/downward movement direction of the rod 130 may be defined to be longer than a maximum pushing distance of the rod 130 (a distance by which the rod is maximally pushed by an external force applied to the rod) relative to the housing 110 in the upward/downward movement direction of the rod 130 (an axial direction of the rod 130).

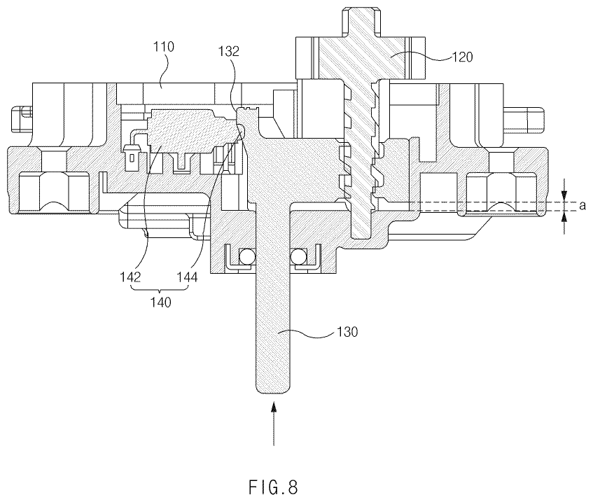

This is based on the fact that when an external force is applied (an external force is applied when the user pulls the charger forward or rearward) during the process of charging the battery, the rod 130 may be pushed (pushed in the upward direction based on FIG. 8), and the contact between the contact protrusion 132 and the switch 140 is released (an erroneous operation occurs) as the rod 130 is pushed. In the embodiment of the present disclosure, as illustrated in FIG. 8, the length of the contact section CS is defined to be longer than the maximum pushing distance (see a in FIG. 8) of the rod 130 so that the state in which the electric circuit 140a is connected may be maintained even when the rod 130 is pushed.

For example, a length (see b in FIG. 1) of the contact surface of the contact protrusion 132, a length C of the contact surface of the contact part 144, and the length of the contact section CS between the contact part 144 and the contact protrusion 132 may all be defined to be longer than the maximum pushing distance a of the rod 130 (b>a, C>a, and CS>a).

For example, the maximum pushing distance a of the rod 130 may be 0.83 mm in consideration of backlashes and an angle (e.g., 30 degrees) at which one tooth of the gear part 120 (e.g., the spur worm gear) rotates. However, in case that the length of the contact section CS between the contact part 144 and the contact protrusion 132 is longer than 0.83 mm (e.g., the length of the contact section is set to 1.5 mm), it is possible to prevent the release of the contact between the contact protrusion 132 and the switch 140 (erroneous operation) and detect an accurate operating position of the rod 130 even when the rod 130 is pushed.

According to the embodiment of the present disclosure as described above, it is possible to obtain an advantageous effect of improving stability and reliability.

In particular, according to the embodiment of the present disclosure, it is possible to obtain an advantageous effect of minimizing an erroneous operation of the actuator and minimizing a charging error and a charging defect.

Among other things, according to the embodiment of the present disclosure, it is possible to detect an accurate operating position of the rod and minimize an erroneous operation of the switch caused by a change in posture of the rod even though an external force is applied to the rod.

In addition, according to the embodiment of the present disclosure, it is possible to obtain an advantageous effect of preventing a charging interruption and an inability to detach the charger caused by an erroneous operation of the switch.

While the embodiments have been described above, the embodiments are just illustrative and not intended to limit the present disclosure. It can be appreciated by those skilled in the art that various modifications and applications, which are not described above, may be made to the present embodiment without departing from the intrinsic features of the present embodiment. For example, the respective constituent elements specifically described in the embodiments may be modified and then carried out. Further, it should be interpreted that the differences related to the modifications and applications are included in the scope of the present disclosure defined by the appended claims.

1. An actuator comprising:
a housing;
a gear part rotatably positioned on the housing;
a rod having a contact protrusion and configured to be movable upward or downward relative to the housing depending on a rotation of the gear part; and
a switch positioned in the housing and configured to define an electric circuit electrically connected to a switch resistor, the switch being configured to connect or disconnect (ON/OFF) the electric circuit depending on contact of the contact protrusion;
wherein the switch includes a safety switch driving section in which a state in which a movement of the contact protrusion relative to the switch is allowed and the electric circuit is connected (ON) is maintained; and
wherein the switch and the contact protrusion are positioned adjacent to each other so that the movement of the contact protrusion relative to the switch is performed in the safety switch driving section.

2. The actuator of claim 1, wherein the switch comprises:
a main body part positioned in the housing and configured to define the electric circuit electrically connected to the switch resistor; and
a contact part positioned on the main body part and configured to be rectilinearly movable in a direction in which the contact part moves toward or away from the contact protrusion, the contact part being further configured to connect or disconnect the electric circuit while rectilinearly moving relative to the main body part depending on the contact of the contact protrusion.

3. The actuator of claim 2, wherein a length of a contact section between the contact part and the contact protrusion in an upward and downward movement direction of the rod is longer than a maximum pushing distance of the rod relative to the housing in the upward and downward movement direction of the rod.

4. The actuator of claim 1, wherein a maximum movement distance of the contact protrusion relative to the switch is included in the safety switch driving section.

5. The actuator of claim 1, wherein the safety switch driving section has a shorter length than an overall switch driving section of the switch in which the electric circuit is connected (ON) by the contact of the contact protrusion.

6. The actuator of claim 5, wherein the overall switch driving section is positioned between a maximum pushing point of the switch and a switch disconnection point at which the electric circuit is disconnected (OFF), and
wherein the safety switch driving section is positioned between a first reference point, spaced apart from the maximum pushing point by a first reference distance in a direction in which the switch is pushed, and a second reference point spaced apart from the switch disconnection point by a second reference distance in the direction in which the switch is pushed.

7. The actuator of claim 6, wherein the maximum pushing point is spaced apart from a reference point, which is positioned on the housing, by 5.1 mm in the direction in which the switch is pushed;
wherein the switch disconnection point is spaced apart from the reference point by 6.8 mm in the direction in which the switch is pushed;
wherein the first reference point is spaced apart from the reference point by 5.8 mm in the direction in which the switch is pushed; and
wherein the second reference point is spaced apart from the reference point by 6.4 mm in the direction in which the switch is pushed.

8. The actuator of claim 1, wherein the movement of the contact protrusion relative to the switch includes at least any one of pushing of the rod relative to the housing by an external force applied to the rod, and tilting of the rod relative to the housing.

9. The actuator of claim 1, wherein a total resistance value of the electric circuit varies depending on the connection or disconnection of the electric circuit.
